(19) United States
(12) Patent Application Publication
(10) Pub. No.: US 2014/0074618 A1
(43) Pub. Date: Mar. 13, 2014

(54) Advertisement Communication And Revenue Sharing

(71) Applicant: Ankit Surendrakumar Agarwal, London (GB)

(72) Inventor: Ankit Surendrakumar Agarwal, London (GB)

(21) Appl. No.: 14/063,098

(22) Filed: Oct. 25, 2013

Related U.S. Application Data
(63) Continuation-in-part of application No. 13/910,117, filed on Jun. 5, 2013, now Pat. No. 8,589,217.
Application No. 13/910,117 is a continuation of application No. 11/985,955, filed on Nov. 19, 2007, now Pat. No. 8,484,074.

(51) Int. Cl. G06Q 30/02

(52) U.S. Cl. CPC G06Q 30/0267
USPC 705/14.64

(57) ABSTRACT

A computer implemented method and system generates revenue and shares the generated revenue. An advertisement management platform (AMP) receives advertisements, for example, advertisement tunes, text messages, audio messages, video messages, etc., from one or more advertisers. The AMP acquires permission from a subscriber for inserting advertisements in phone calls and messaging service messages of the subscriber. The AMP inserts the advertisements by replacing a ring back tone of the phone call with the advertisements or by interrupting the phone call and presenting the advertisements. The AMP inserts the advertisements during an initiation, an active state, an engaged state, or a termination of the phone call. Furthermore, the AMP inserts the advertisements at the beginning or the end of the messaging service messages of the subscriber. The AMP shares the revenue generated from advertising with the subscriber through discounts on call charges, through predetermined amount payments to the subscriber, etc.

### CROSS REFERENCE TO RELATED APPLICATIONS

This application is a continuation-in-part application of patent application Ser. No. 13/910,117, titled “Advertisement Tunes And Messages” filed on Jun. 5, 2013, which is a continuation application of non-provisional patent application Ser. No. 11/985,955, now U.S. Pat. No. 8,484,074, titled “Advertisement Tunes and Messages”, filed on Nov. 19, 2007 in the United States Patent and Trademark Office. The specifications of the above mentioned patent applications and the patent are incorporated herein by reference in their entirety.

### BACKGROUND

The computer implemented method and system disclosed herein, in general, relates to generation of revenue by a telecommunication (telecom) company. More particularly, the computer implemented method and system disclosed herein relates to generating revenue by placing advertisements in phone calls and messaging service messages of telecom consumers and sharing the generated revenue with the telecom consumers.

The widespread use of mobile communication devices has enabled different methods of advertising through these mobile communication devices. The existing methods of advertising on a mobile communication device, for example, a mobile phone typically involve intrusive modes such as unsolicited phone calls or text messages from advertisers without the assent of the consumers. In addition to being intrusive, these modes of advertising offer no monetary benefits to the consumers and hence are not well received.

In today's world, a mobile phone ranks immediately after food, water, and air as a necessity of life. Moreover, mobile phones being carried by mobile users almost anywhere and everywhere facilitate immediate product recall resulting in immediate sales of the product. Advertising on mobile phones has a number of advantages, for example, farther reach, greater visibility, brand recall, and ability to target a particular group of consumers, etc., making mobile advertising one of the popular forms of advertising. The mobile advertising medium can be efficiently tapped by ensuring active participation of the consumers in receiving the advertisements. Hence, there is a need for ensuring active participation of the consumers by rewarding them for receiving the advertisements.

Furthermore, the current scenario in the telecom industry is that a telecom consumer uses telecom services provided by a telecom company and pays a bill amount to the telecom company. There is a need for a computer implemented method and system that benefits the telecom company, the telecom consumer, and other entities participating in the processes involved in the telecom industry.

Hence, there is a long felt but unresolved need for a computer implemented method and system that generates revenue by advertising on phone calls and messaging service messages of the consumers with the consent of the consumers. Furthermore, there is a need for a computer implemented method and system that rewards the consumers for receiving the advertisements, thereby ensuring active participation of the consumers and effective advertising on mobile phones.

### SUMMARY OF THE INVENTION

This summary is provided to introduce a selection of concepts in a simplified form that are further disclosed in the detailed description of the invention. This summary is not intended to identify key or essential inventive concepts of the claimed subject matter, nor is it intended for determining the scope of the claimed subject matter.

The computer implemented method and system disclosed herein addresses the above stated needs for generating revenue by advertising on phone calls and messaging service messages of consumers with the consent of the consumers. Furthermore, the computer implemented method and system disclosed herein enables sharing of the generated revenue with consumers or subscribers, thereby ensuring active participation of the consumers and effective advertising on mobile communication devices such as mobile phones. As used herein, the term “subscriber” refers to a user, a customer, or a consumer who subscribes to a telecommunication (telecom) company to receive telecom services, advertising services, offers, etc. The telecom company receives advertisements from one or more of multiple advertisers. The advertisements comprise, for example, advertisement tunes, advertisement ring tones, text messages, audio messages, video messages, etc., and any combination thereof. The advertisers are, for example, business enterprises, corporations, industries, product and/or service companies, individual advertisers, etc. The telecom company acquires permission from a subscriber for inserting the received advertisements in phone calls and/or messaging service messages of the subscriber. The messaging service messages comprise, for example, a text short message service (SMS) message, a voice SMS, a multimedia messaging service (MMS) message, an enhanced messaging service (EMS) message, an extended messaging service (XMS) message, etc. The telecom company generates revenue by inserting one or more advertisements in the phone calls and/or the messaging service messages based on the permission from the subscriber. The telecom company shares the generated revenue with the subscriber.

The telecom company receives advertisements from one or more of multiple advertisers that wish to advertise through the telecom company. The telecom company and the advertisers mutually agree upon the advertising charges. The advertising charges are determined by the telecom company, for example, based on the duration or length of the advertisements, a point of insertion of each of the advertisements in the phone call and the messages, etc. The telecom company, therefore, generates revenue by inserting advertisements obtained from the advertisers in the phone calls and messages of the subscriber.

The subscriber permits the telecom company to advertise on phone calls and messages either initiated or received by the subscriber, by selecting from multiple advertising schemes offered by the telecom company. In the case of advertising on the phone calls of the subscriber, the advertisements are inserted in one or more of an initiation, an active state, an engaged state, and a termination, etc., of the phone call. In an embodiment, an advertisement tune is used to replace the ring back tone of the phone call. When a caller calls a subscriber, instead of hearing the ring back tone, the caller listens to an advertisement tune that is used to replace the ring back tone. In another embodiment, the advertisement tunes are played to the caller and the subscriber during an active state of the phone call, that is, when the caller and the subscriber are engaged in a conversation. In yet another embodiment, the advertisement tune is played to the caller and the subscriber immediately after the phone call has been terminated by either the caller or the subscriber. In the case of advertising on the messaging service message of the subscriber, the telecom company introduces advertisements at the beginning and/or at the end of the messaging service message.

The subscriber is remunerated for permitting the insertion of advertisements comprising, for example, advertisement tunes, text messages, audio messages, or video messages in one of the phone calls and/or the messaging service messages. The telecom company shares the revenue generated through advertising with the subscriber, for example, by offering discounts on call charges, by paying a predefined amount back to the subscriber, etc. The revenue shared with the subscriber is determined, for example, based on the advertising scheme selected by the subscriber, the number of phone calls or messages received or initiated by the subscriber, etc.

Also, disclosed herein is a computer implemented method and system for advertising. The computer implemented method and system disclosed herein provides an advertisement management platform comprising at least one processor configured to generate revenue by the advertising. In an embodiment, the advertisement management platform is hosted, for example, by one or more of a network provider, a company to be advertised, a third party entity, an advertiser, a seller, etc., and any combination thereof. The network provider is a communication provider or a service provider, for example, a telecom company that provides telecom services to consumers. The advertisement management platform is accessible, for example, by one or more of the telecom company, a company to be advertised, a third party entity, an advertiser, a seller, etc., and any combination thereof, via a network, for example, the internet, a telecommunication network, etc. In an embodiment, the advertisement management platform acquires permission from a first user and/or a second user for inserting one or more advertisements in a communication sequence between the first user and the second user. As used herein, the terms “first user” and the “second user” refer to entities that communicate with each other through a communication link between their communication devices via a network. The first user is, for example, a mobile phone user called by another mobile phone user via a telecommunication or telephone network. The second user is, for example, a mobile phone user calling another mobile phone user via a telecommunication or telephone network. Also, as used herein, the term “communication sequence” refers to a telephonic communication between a calling entity and a called entity via a network. The communication sequence is, for example, a phone call, a video call, a conference phone call, a conference video call, etc. In an embodiment where multiple users communicate with each other in a single communication sequence, for example, a conference call, the advertisement management platform acquires permission for inserting one or more advertisements in the communication sequence from one or more of the users. In another embodiment, the advertisement management platform does not request permission from the users for inserting the advertisements in the communication sequence.

The advertisement management platform inserts one or more advertisements in the communication sequence between the users, for example, the first user and the second user by replacing a ring back tone of the communication sequence with the advertisements or by interrupting the communication sequence and presenting the advertisements. In an embodiment, the advertisement management platform inserts one or more advertisements before an initiation of the communication sequence. In an embodiment, the advertisement management platform presents the advertisements within a media message. As used herein, the term “media message” refers to a message that can be transmitted and/or received on a user's communication device, for example, a cellular phone, a smart phone, a tablet computing device, etc., or any other mobile device configured for communication via a network. The media message is, for example, a text short message service (SMS) message, a voice short message service message, a multimedia messaging service (MMS) message, an enhanced messaging service (EMS) message, an extended messaging service (XMS) message, etc., of a subscribing user.

The advertisement management platform generates revenue from the insertion of the advertisements and shares the generated revenue with one or more of the users and a third party entity responsible for the insertion of the advertisements. In an embodiment, the advertisement management platform hosted by an advertiser shares revenue with the network provider. The advertisement management platform generates the revenue, for example, based on one or more of a duration of each of the advertisements, a point of insertion of each of the advertisements in the communication sequence, a time of insertion of each of the advertisements in the communication sequence, etc.

In an embodiment, the advertisement management platform provides an option to purchase one or more products and/or services advertised in the inserted advertisements in the communication sequence to one or more of the users. In this embodiment, the advertisement management platform transfers the communication sequence between the users to a marketing entity via multiple communication modes for facilitating the purchase of one or more of the products and/or the services advertised in the inserted advertisements. As used herein, the term “marketing entity” refers to a professional, a team of professionals, or an organization that engages in marketing, publicity, promotion, sale, etc., of a product and/or a service. The marketing entity is, for example, an advertiser, a customer care representative, a sales representative, a seller, etc. The communication modes comprise, for example, electronic mail (email), a short message service (SMS) message, a multimedia messaging service (MMS) message, etc. Furthermore, in this embodiment, the advertisement management platform shares the revenue generated by a sale of the products and/or services advertised in the inserted advertisements by the marketing entity with a network provider that manages the communication sequence, one or more of the users, and/or a third party entity responsible for the insertion of the advertisements via the advertisement management platform. In an embodiment, if a sale is made over the advertisement, the advertiser may directly share revenue with the subscriber playing the advertisement. The advertiser may share the revenue with the subscriber through the network provider or through other means. Furthermore, in this embodiment, the advertisement management platform executes a payment transaction with one or more of the users during the purchase of the products and/or the services advertised in the inserted advertisements. In an embodiment, the advertisement management platform shares the revenue generated from the insertion of the advertisements and/or the sale of the products and/or the services advertised in the inserted advertisements with one or more of the users based on one or more conditions, for example, duration of the communication sequence, call charges, etc.

In an embodiment, the advertisement management platform provides one or more offers to multiple users for enabling the users to perform a bulk purchase of the products and/or the services advertised in the inserted advertisements. In an embodiment, the advertisement management platform executes a sale for one or more slots of the communication sequence from a first network provider to a second network provider for enabling the second network provider to insert one or more advertisements in those slots of the communication sequence. In another embodiment, the advertisement management platform manages a gaming activity at configurable time instants of the communication sequence and executes a payment transaction with one or more of the users for participating in the gaming activity. The gaming activity is, for example, a lottery, a jackpot quiz, etc. The configurable time instants of the communication sequence comprise, for example, an initiation of the communication sequence, an active state, an engaged state, a termination of the communication sequence, a hold state, etc.

In an embodiment, the advertisement management platform analyzes the communication sequence between the users, and targets and inserts one or more advertisements in the communication sequence based on the analysis of the communication sequence between the users. In an embodiment, the advertisement management platform acquires permission from one or more of the users to allow the analysis of the communication sequence between the users. In another embodiment, the advertisement management platform does not request permission from the users to allow the analysis of the communication sequence between the users.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and components disclosed herein.

FIG. 1 illustrates a computer implemented method for generating revenue by a telecommunication company and sharing the generated revenue with a subscriber.

FIG. 2 illustrates a computer implemented system for generating revenue by a telecommunication company and sharing the generated revenue with a subscriber.

FIG. 3 exemplarily illustrates a flowchart comprising the steps for receiving advertisements from one or more of multiple advertisers.

FIG. 4 exemplarily illustrates a flowchart comprising the steps for acquiring permission from a consumer for advertising.

FIG. 5 exemplarily illustrates a flowchart comprising the steps for advertising on a phone call initiated by a caller to a subscriber.

FIG. 6 exemplarily illustrates a flowchart comprising the steps for inserting advertisements in a messaging service message.

FIG. 7 illustrates a computer implemented method for advertising.

FIG. 8 exemplarily illustrates a flow diagram showing interactions between a telecommunication company, a company to be advertised, and users according to the computer implemented method disclosed herein.

FIG. 9 exemplarily illustrates a computer implemented system for advertising.

FIG. 10 exemplarily illustrates the architecture of a computer system employed by an advertisement management platform for advertising.

### DETAILED DESCRIPTION OF THE INVENTION

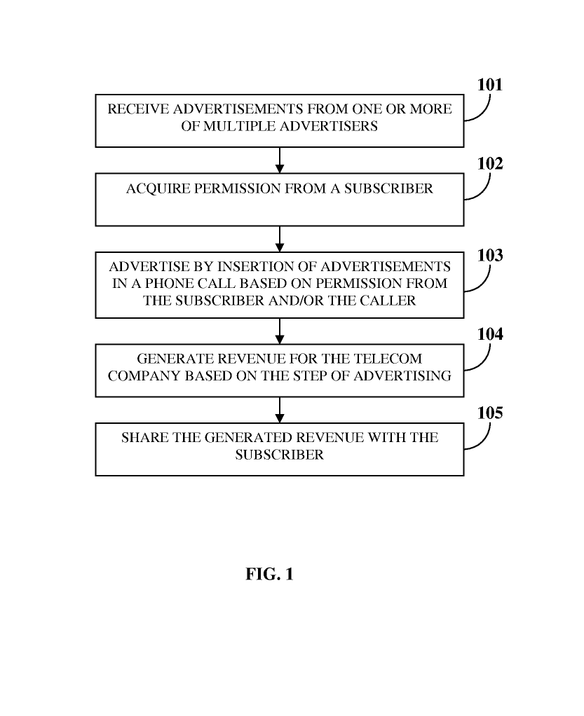

FIG. 1 illustrates a computer implemented method for generating revenue by a telecommunication (telecom) company and sharing the generated revenue with a subscriber. As used herein, the term “subscriber” refers to a user, a customer, or a consumer who subscribes to the telecom company to receive telecom services, advertising services, offers, etc. The telecom company receives 101 advertisements from one or more of multiple advertisers. The advertisements comprise, for example, advertisement tunes, advertisement ring tones, text messages, audio messages, video messages, etc., and any combination thereof. The advertisers are, for example, business enterprises, corporations, industries, product and/or service companies, individual advertisers, etc. The telecom company acquires 102 permission from a subscriber for inserting advertisements in phone calls and messages of the subscriber. The subscriber is one of the consumers of the telecom company, where the consumer is referred to as subscriber, once the consumer subscribes to the advertising services of the telecom company. The subscriber selects from one of multiple advertising schemes offered by the telecom company. The advertising schemes are more thoroughly described hereunder in the detailed description of FIG. 1. The telecom company advertises 103 by inserting advertisements in a phone call based on permission from the subscriber and/or the caller and in turn generates 104 revenue. The phone call is initiated or received by the subscriber. The telecom company shares 105 the generated revenue with the subscriber.

The advertisements are inserted during, for example, an initiation, an active state, an engaged state, a termination, etc., of the phone call. In the case of a caller initiated phone call, a caller calls the subscriber. Advertisements from different advertisers are inserted in one phone call, for example, during the initiation, the active state, the engaged state, the termination, etc., of the phone call. In an embodiment, a ring back tone in the caller initiated phone call is replaced with an advertisement tune provided by the advertisers. The advertisement tune comprises, for example, a mandatory message, a tag line, and a short advertisement. In the caller initiated phone call, the caller listens to the advertisement tune before the subscriber answers the phone call. In one implementation of the computer implemented method disclosed herein, the caller has to listen to the advertisement tune until the playing of the mandatory message is completed before the caller engages in a conversation with the subscriber. The mandatory message is played to circumvent the possibility that the subscriber answers the phone call before the caller has a chance to listen to the advertisement tune. The mandatory message may state that the phone call is sponsored by the advertiser. For example, the mandatory message states “This call to the subscriber is sponsored by company A, the number one cell phone company in the world.” In an embodiment, the caller does not need to wait for completion of the mandatory message or the advertisement tune before engaging in a conversation with the subscriber.

In the case of a subscriber initiated phone call, the subscriber makes a phone call to a recipient. The subscriber hears the advertisement tune replacing the ring back tone in the subscriber initiated phone call. After the recipient answers the phone call, the recipient gets to listen to the advertisement tune. In this implementation, both the subscriber and the recipient listen to the advertisement tune prior to the beginning of the conversation between them. Further, the computer implemented method disclosed herein allows insertion of video advertisements in the subscriber initiated phone call such that the subscriber views the video advertisement until the phone call is answered by the recipient. In an embodiment, after the recipient answers the phone call, the recipient does not need to listen to the advertisement tune.

In another embodiment, the caller initiated phone call and the subscriber initiated phone call are interrupted after a predetermined time limit and the tag line and/or the short advertisement is played to the subscriber and the caller engaged in the phone call. The subscriber may select the periodicity of insertion of the advertisements in the active state of the phone call. Further, upon termination of the phone call, advertisement tunes are played to the subscriber and the caller or the recipient.

In an embodiment, the telecom company inserts an advertisement into a messaging service (MS) message sent by the subscriber. An MS message is, for example, a text short message service (SMS) message, a voice SMS message, a multimedia messaging service (MMS) message, an enhanced messaging service (EMS) message, or an extended messaging service (XMS) message. The advertisements are inserted at the beginning or at the end of the MS message. The advertisements inserted in the MS messages comprise, for example, a text advertisement, an audio advertisement, a video advertisement, and other multimedia advertisements. Further, the revenue generated by the telecom company by inserting advertisements in the MS messages of the subscriber is shared with the subscriber.

The subscriber subscribes to one or more of multiple advertising schemes offered by the telecom company. Through the advertising schemes, the subscriber permits the telecom company to insert advertisements in the phone calls or the messaging service (MS) messages of the subscriber. Further, the subscriber may select the point of insertion of the advertisements in the phone calls and the messages. For example, the subscriber may want advertisements to be inserted only at the initiation and the termination of the phone calls. In order to seek more remuneration, the subscriber may want advertisements to be inserted at periodic intervals during the active state of the phone call. Furthermore, the advertising schemes also determine the amount of the generated revenue to be shared with the subscriber.

The advertising schemes comprise, for example, a random advertising scheme, a one set advertising scheme, and a time specific advertising scheme. In the random advertising scheme, the telecom company randomly selects an advertisement received from one or more of multiple advertisers and inserts the selected advertisement in the phone calls or the messaging service messages opted by the subscriber. In an embodiment, when the subscriber selects the random advertising scheme, the subscriber has no control on the selection of the advertisement to be inserted in the phone call and money received by the subscriber is as per a predetermined rate of each advertisement set by the telecom company. For example, during the first phone call, the subscriber and/or the caller or the recipient may listen to an advertisement of a mobile phone company. During the second phone call, they may listen to a soft drink promotional advertisement.

In the one set advertising scheme, the telecom company plays the advertisements of a single advertiser to a selected group of subscribers. The one set advertising scheme is suitable, for example, for corporate subscribers that are employees of a corporate body or a company. The one set advertising scheme can be used by a corporate company that wishes that people only hear advertisements about the corporate company when they call any employee of the corporate company. In an embodiment, the one set advertising scheme supersedes the time specific advertising scheme. For example, the telecom company inserts corporate advertisements of the corporate body in the phone calls and messaging service messages of the corporate subscribers, whereby the corporate body may advertise itself to the people calling any of the corporate subscribers. For example, a credit card company may want to advertise the credit card company for brand imaging. The credit card company sets its own advertisements on corporate numbers or contact numbers of its employees. Using the one set advertising scheme, the credit card company ensures that a caller making a phone call to the credit card company's corporate numbers or to the employees of the credit card company listens to the advertisement of the credit card company.

In the time specific advertising scheme, an advertiser agrees upon a time slot for advertising with the telecom company. The telecom company inserts advertisements of the advertiser in all the permitted phone calls handled by the telecom company during the agreed time slot. The time slot is, for example, a daily time slot, an hourly time slot, a minutely time slot, a monthly time slot, a yearly time slot, etc. For example, a mobile phone company may want to advertise a new mobile phone model on the day of launch of the phone model. The mobile phone company in agreement with the telecom company uses the time specific advertising scheme to advertise the mobile phone model. On the day of launch, the telecom company inserts advertisements of the mobile phone model in all the permitted phone calls handled by the telecom company on that day. In an embodiment, the time specific advertising scheme supersedes the random advertising scheme but not the one set advertising scheme.

The telecom company generates revenue by permitting advertisers to insert advertisements in the phone calls and messaging service (MS) messages of the subscribers. The advertisers agree upon the advertising charges with the telecom company at a predetermined rate or a variable rate and pay the advertising charges to the telecom company as per the agreed rate. The advertising charges depend on a number of factors including whether the advertisements are inserted in the phone calls or in the MS messages, the length or duration of the advertisements, the point of insertion of the advertisements in the phone calls and the MS messages, etc. For example, the advertising charges for advertisements inserted during the initiation of a phone call or at the beginning of an MS message may be more than the charges for advertisements inserted at phone call termination.

The revenue generated by the telecom company is shared with the subscriber, for example, by offering discounts on call charges to the subscriber or by remunerating the subscriber for allowing advertisements. The discounts offered on call charges may be at a predetermined rate or may vary according to the advertising scheme selected by the subscriber. The subscriber is, for example, remunerated through a payment amount or compensated through deductions in the phone bill. Further, the telecom company may remunerate the subscriber, for example, by offering certain telecom services to the subscriber free of cost. For example, if the subscriber permits the insertion of advertisements in text short message service (SMS) messages, the telecom company may allow the subscriber to send a hundred text SMS messages free of cost. Further, a subscriber permitting the insertion of advertisements in between an active phone call may obtain more waivers on call charges than a subscriber permitting insertion of advertisements at the beginning or the end of the phone call. In an embodiment, the generated revenue is shared with the subscriber only when the phone call is received. Furthermore, the sharing of the generated revenue is determined, for example, by the number of phone calls received or made by the subscriber.

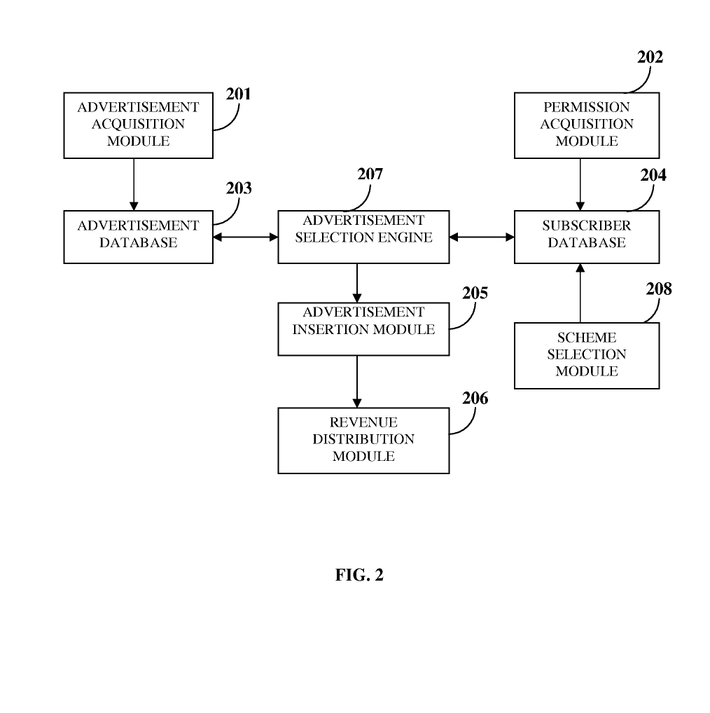

FIG. 2 illustrates a computer implemented system for generating revenue by a telecommunication (telecom) company and sharing the generated revenue with a subscriber. The computer implemented system disclosed herein comprises an advertisement acquisition module 201, a permission acquisition module 202, a scheme selection module 208, an advertisement selection engine 207, an advertisement insertion module 205, a revenue distribution module 206, an advertisement database 203, and a subscriber database 204. The advertisement acquisition module 201 receives advertisements from multiple advertisers and stores the received advertisements in the advertisement database 203. The advertisements are organized in the advertisement database 203, for example, based on the personal preferences of subscribers, the type of advertisements, the point of insertion of the advertisements during the phone call, and the advertising scheme selected by the subscribers.

The permission acquisition module 202 acquires permission from the subscriber for advertising during a communication between the subscriber and the caller either over a phone call or a messaging service (MS) message. In an embodiment, permission for inserting advertisements during the communication between the subscriber and the caller is not acquired from the subscriber. The subscriber database 204 is used to store the profiles of the subscribers. Each subscriber profile comprises, for example, personal information of the subscriber such as age, address information, locality of residence, profession, hobbies, interests, etc. The subscriber profile also stores, for example, the preferred type of advertisements, the stage of the phone call when the advertisements are to be inserted, the advertising schemes selected by the subscriber, etc. The subscriber profile may be used by advertisers to insert advertisements relevant to the subscriber and to advertise to a select target group of subscribers. For example, a subscriber may be a college student with an interest in electronic hobby kits. The telecom company may insert advertisements of electronic hobby shops in the phone calls and MS messages of the college student. The electronic hobby shops are more likely to reach out to other electronic hobbyists who are callers or recipients of phone calls from the college student.

The scheme selection module 208 selects from one or more of multiple advertising schemes based on subscriber inputs or preferences. The advertising schemes comprise, for example, a random advertising scheme, a one set advertising scheme, a time specific advertising scheme, etc., as disclosed in the detailed description of FIG. 1. The advertisement selection engine 207 analyzes the subscriber profiles stored in the subscriber database 204 and based on the preferences of the subscriber and the advertising scheme selected by the subscriber, selects advertisements to be inserted in the phone call or messaging service (MS) messages of the subscriber. The advertisement selection engine 207 selects advertisements, for example, by comparing the subscriber profile with the organized advertisements in the advertisement database 203 until a match is found. Further, the advertisement selection engine 207 also determines the type of advertisement to be inserted. For example, the advertisement selection engine 207 selects an advertisement tune for insertion in a phone call. For the insertion of advertisements to a text short message service (SMS) message and a multimedia messaging service (MMS) message, the advertisement selection engine 207 selects, for example, a text advertisement and a video advertisement respectively. The selected advertisement is conveyed to the advertisement insertion module 205. Further, the advertisement selection engine 207 selects advertisements of different advertisers to be inserted on the same phone call or MS messages.

The advertisement insertion module 205 inserts the selected advertisement in the phone call or the MS message as selected by the subscriber. The advertisement insertion module 205 determines the point of insertion of the advertisement in the phone call or the MS message. The advertisement insertion module 205 inserts the selected advertisement during an initiation, an active state, an engaged state, or a termination, etc., of the phone call. Further, the advertisement insertion module 205 inserts the advertisements in the beginning or the end of an MS message. The revenue distribution module 206 calculates the revenue generated by the telecom company through the advertisements. The revenue distribution module 206 also calculates the portion of revenue to be shared with the subscriber. The revenue distribution module 206 determines discounts and waivers on call charges, free telecom services to be provided to the subscriber, payment amounts, etc., admissible to the subscriber for permitting the insertion of the advertisements.

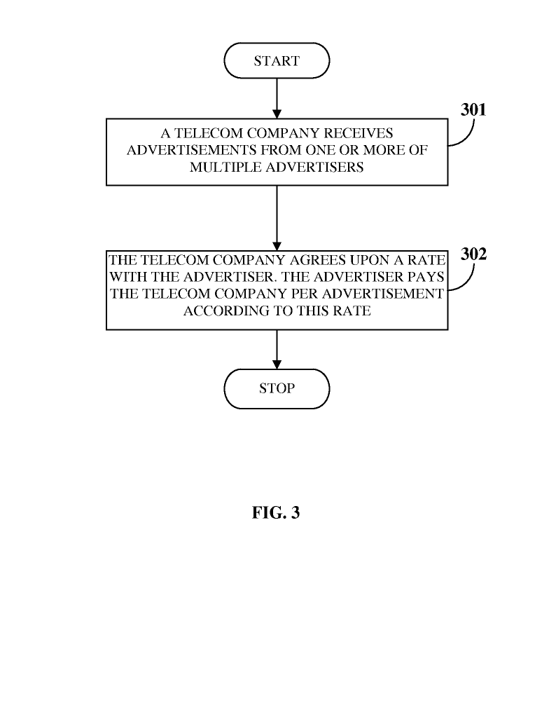

FIG. 3 exemplarily illustrates a flowchart comprising the steps for receiving advertisements from one or more of multiple advertisers. A telecom company collaborates with a company or multiple advertisers that wish to advertise their products and/or services through the telecom company. The telecom company receives 301 advertisements from one or more of multiple advertisers through the advertisement acquisition module 201 and stores the advertisements in the advertisement database 203 exemplarily illustrated in FIG. 2. The advertisements are, for example, an advertisement tune, a text advertisement, an audio advertisement, a video advertisement, etc., and any combination thereof. The telecom company fixes or agrees upon 302 a rate with each advertiser. The telecom company and each advertiser agree upon the advertising charges at a predetermined rate or a variable rate. The advertisers pay the telecom company for insertion of their advertisements as per the agreed rate of advertising charges. The steps of receiving advertisements and determining the advertising charges are disclosed in the detailed description of FIG. 1.

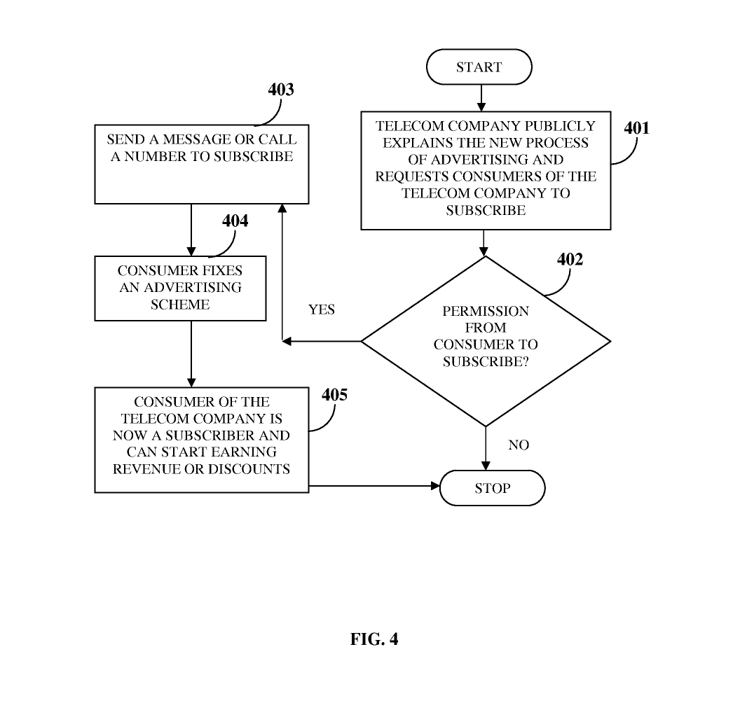

FIG. 4 exemplarily illustrates a flowchart comprising the steps for acquiring permission from a consumer for advertising. The telecom company publicly announces and explains 401 the new process of advertising and the benefits for the consumers by subscribing to the advertising schemes disclosed in the detailed description of FIG. 1, and requests consumers of the telecom company to subscribe. The consumers can opt for one of the advertising schemes for inserting advertisements in phone calls or messaging service (MS) messages of the consumers. The telecom company seeks 402 permission from a consumer for advertising on the consumer's phone calls and MS messages. For example, the telecom company requests the consumer to send 403 a short message service (SMS) message or call a number to subscribe to one of the advertising schemes. Once the consumer subscribes, advertisements are inserted in the phone calls and MS messages of the consumer. In an embodiment, the telecom consumer fixes 404 an advertising scheme with the telecom company for insertion of the advertisements. The consumer after subscribing to the advertising scheme is now a subscriber 405 and can start earning revenue or obtaining discounts from the telecom company. If the telecom consumer does not subscribe for advertising, the telecom consumer is not a subscriber and the telecom company does not place advertisements on the telecom consumer's number.

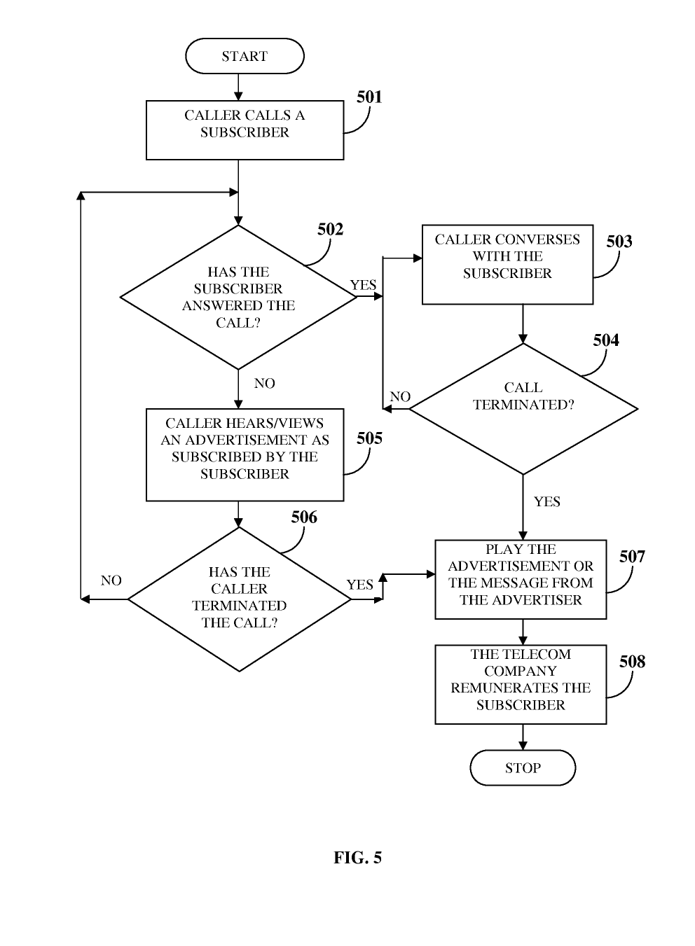

FIG. 5 exemplarily illustrates a flowchart comprising the steps for advertising on a phone call initiated by a caller to a subscriber. In an example, when a caller calls 501 a subscriber, the caller listens to an advertisement tune that is used to replace the ring back tone of the phone call. If the subscriber does not answer 502 the phone call, the caller hears or views an advertisement as subscribed by the subscriber. The caller continues to hear or view 505 the advertisement as subscribed by the subscriber until the subscriber answers 502 the phone call or the caller terminates 506 the phone call before the phone call is answered by the subscriber. The advertisement subscribed by the subscriber is, for example, an advertisement tune, a text advertisement, an audio advertisement, or a video advertisement. The caller converses 503 with the subscriber after the subscriber answers the phone call. After the termination 506 or 504 of the phone call by the caller or the subscriber, an advertisement is played or a message is sent 507 from the advertisers to the caller and/or the subscriber. For example, if the caller or the subscriber hangs up the phone call, the telecom company plays an advertisement or a message, for example, “This call was brought to you by xyz”. The telecom company then remunerates 508 the subscriber for permitting the insertion of the advertisement during the phone call. For example, the telecom company pays money into the subscriber's advertisement account for allowing insertion of the advertisement in the phone call initiated by the caller.

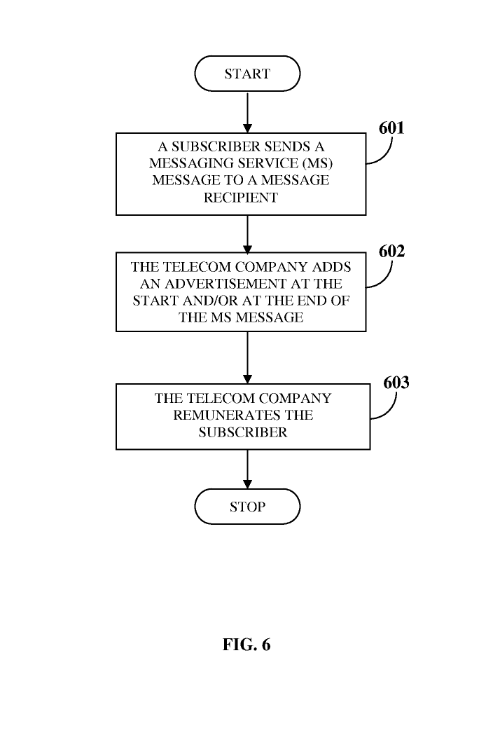

FIG. 6 exemplarily illustrates a flowchart comprising the steps for inserting advertisements in a messaging service (MS) message. The subscriber sends 601 an MS message to a message recipient. The MS message is, for example, a text short message service (SMS) message, a voice SMS message, a multimedia messaging service (MMS) message, an enhanced messaging service (EMS) message, an extended messaging service (XMS) message, an audio message, etc. The telecom company adds 602 an advertisement at the start and/or the end of the MS message. The type of advertisement added depends on the type of the MS message being sent by the subscriber. For example, a text advertisement is inserted in a text SMS message and a video advertisement is inserted in an MMS message. The telecom company remunerates 603 the subscriber for permitting the insertion of advertisements in the MS message. For example, the telecom company pays money into the subscriber's advertisement account.

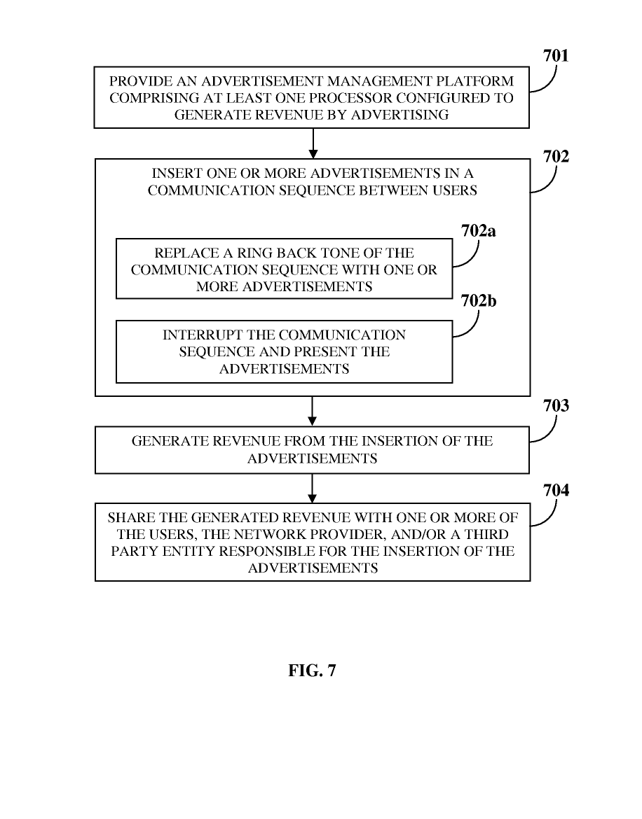

FIG. 7 illustrates a computer implemented method for advertising. The computer implemented method disclosed herein provides 701 an advertisement management platform comprising at least one processor configured to generate revenue by advertising. In an embodiment, the advertisement management platform is hosted, for example, by one or more of a network provider, a company to be advertised, a third party entity, an advertiser, a seller, etc., and any combination thereof. The network provider is a communication provider or a service provider, for example, a telecom company that provides telecom services, for example, Skype® of Skype Corporation, gTalk® of Genusys Inc., Windows Live® of Microsoft Corporation, Yahoo! ® messenger of Yahoo! Inc., voice over internet protocol (VoIP) services, etc., to consumers. In an embodiment, the network provider does not host the advertisement management platform and employs a third party entity to host the advertisement management platform or combines operations of hosting the advertisement management platform with another network provider.

The advertisement management platform is accessible, for example, through a broad spectrum of technologies and devices such as personal computers with access to the internet, internet enabled cellular phones, tablet computing devices, etc. The advertisement management platform is accessible, for example, by one or more of the network provider, a company to be advertised, a third party entity, an advertiser, a seller, etc., and any combination thereof, via a network. The network is, for example, the internet, a general packet radio service (GPRS) network, a mobile telecommunication network such as a global system for mobile (GSM) communications network, a code division multiple access (CDMA) network, a third generation (3G) mobile communication network, a fourth generation (4G) mobile communication network, a long-term evolution (LTE) mobile communication network, a public telephone network, etc., or a network formed from any combination of these networks. The network is a telephone network and/or a data network that connects exchanges, switches, etc., for example, a wired telephony network, a wireless network, a voice call network, a signaling system number 7 (SS7) network, an internet protocol data network, other data networks, etc.

In an embodiment, the advertisement management platform acquires permission from one or more of the users involved in a communication sequence, for example, a subscriber and/or a caller for inserting one or more advertisements in the communication sequence. As used herein, the term “communication sequence” refers to a telephonic communication between a calling entity and a called entity via a network. The communication sequence is, for example, a phone call, a video call, a conference phone call, a conference video call, etc. The users involved in the communication sequence are, for example, a subscriber and/or a caller, or multiple users engaged in a conference call. In another embodiment, the advertisement management platform does not request permission from the users, for example, the subscriber and/or the caller for inserting one or more advertisements in the communication sequence. The advertisement management platform inserts 702 one or more advertisements in the communication sequence between the users, for example, the subscriber and the caller by replacing 702a a ring back tone of the communication sequence with one or more advertisements or by interrupting 702b the communication sequence and presenting the advertisements. In an embodiment, the advertisement management platform inserts one or more advertisements before an initiation of the communication sequence. In another embodiment, the advertisement is inserted at the beginning or at the end of the communication sequence.

In an embodiment, the advertisement management platform presents one or more advertisements within a media message. As used herein, the term “media message” refers to a message that can be transmitted and/or received on a user's communication device, for example, a cellular phone, a smart phone, a tablet computing device, etc., or any other mobile device configured for communication via a network. The media message is, for example, a text short message service (SMS) message, a voice short message service message, a multimedia messaging service (MMS) message, an enhanced messaging service (EMS) message, an extended messaging service (XMS) message, etc., of a subscribing user. For example, the advertisement management platform inserts a video ring back tone having an advertisement in a conversation between a subscriber and a caller.

The advertisement management platform generates 703 revenue from the insertion of the advertisements. The advertisement management platform generates the revenue, for example, based on one or more of a duration of each of the advertisements, a point of insertion of each of the advertisements in the communication sequence, and a time of insertion of each of the advertisements in the communication sequence. Hence, the network provider attains an additional source of revenue generation. In an embodiment, in case of the insertion of the advertisements, for example, via print media, electronic media, etc., the network provider designs a fee structure to play the advertisement, which is chargeable to advertisers.

The advertisement management platform shares 704 the generated revenue with one or more of the users, for example, the subscriber, the caller, the network provider, and/or a third party entity responsible for the insertion of the advertisements. The third party entity is, for example, an advertising company hired by the company to be advertised for advertising products and/or services of the company to be advertised. Consider an example where a subscriber allows the network provider to insert advertisements in text messages sent by the subscriber to other subscribers. In this example, the network provider remunerates the subscriber via the advertisement management platform with a predefined amount for sending the text messages with the inserted advertisements. Consider another example where a caller C makes a phone call to a subscriber D. Prior to initiation of a conversation, both the caller C and the subscriber D hear a message, for example, “This call is sponsored by company A”, followed by a tag line of the company A and a short advertisement. After a duration of time of, for example, about 2 minutes to about 3 minutes, the advertisement management platform interrupts the phone call and plays the message again and so on till a preset number of times. During this time, the subscriber either bears no call charges or bears discounted call charges only. In an embodiment, the advertisement management platform pays the subscriber, for example, by check monthly, quarterly, etc., which can be a fixed percentage of the number of phone calls received by the subscriber during a predetermined period of time. However, in this embodiment, a subscriber may try to trick the network provider by asking callers to make missed calls to the subscriber's phone number. To ascertain that the subscriber does not try to trick the network provider, the network provider remunerates the subscriber only when he/she receives the phone call. In another example, the advertisement management platform determines the revenue generated from the presentation of advertisements in a telecommunication conference and partially shares the determined revenue with one or more of the users participating in the telecommunication conference.

In an embodiment, the advertisement management platform defines conditions for remunerations. The conditions are, for example, based on call length, call charges, etc., or any combination thereof. In an example, the advertisement management platform and/or the network provider remunerates the subscriber if the call length is X minutes, or if the charges of the call are $Y, or based on multiple combinations such as a call worth $Y for X minutes. In an embodiment, the advertisement management platform provides an option to purchase one or more products and/or services, a subscription to a service, an offer for a telecom service, etc., advertised in the inserted advertisements in the communication sequence to one or more of the users, thereby facilitating an actual sale of the advertised products and/or services. For example, at the start or the end of the communication sequence between a subscriber and a caller, the advertisement management platform provides the subscriber and/or the caller an option to buy or opt in for one or more products, services, subscriptions, offers, etc., advertised, to allow an actual sale to be made. The subscriber and/or the caller and/or any buyer can make a payment for the products, services, subscriptions, offers, etc., for example, through the network provider. The network provider receives payment from the subscriber and/or the caller and/or any buyer via the advertisement management platform to facilitate the purchase of the products and/or the services, the subscription to the service, the offer for the telecom service, etc., advertised in the advertisements inserted in the communication sequence. In an embodiment, the network provider charges the company that made the sale over the network.

In an embodiment, the advertisement management platform shares the revenue generated by sale of the products and/or services advertised in the inserted advertisements by a marketing entity with one or more of the network provider that manages the communication sequence, one or more of the users, for example, the subscriber and/or the caller, and a third party entity responsible for the insertion of the advertisements. Furthermore, in this embodiment, the advertisement management platform executes a payment transaction with one or more of the users during the purchase of the products and/or the services advertised in the inserted advertisements.

In an embodiment, when a sale is made over an advertisement inserted in the communication sequence between the subscriber and the caller, an advertisement company advertising one or more of its products and/or services in the inserted advertisement directly shares the generated revenue with the subscriber playing the advertisement. In another embodiment, the network provider or a third party advertiser shares the generated revenue with the subscriber. The advertisement company entices the subscriber to play the advertisement and provides the subscriber a portion of the revenue generated from the sale of one or more of its products and/or services through the advertisement. The subscriber therefore starts requesting the advertisement company to insert one or more advertisements in the communication sequence, and promotes the advertisement company that pays the subscriber more for inserting the advertisements. By sharing a nominal amount of the revenue generated with the subscribers, the network provider attracts more subscribers, thereby increasing its subscriber base. Moreover, the company advertised by the insertion of advertisements by the network provider is in profit because they get a greater visibility and brand recall. Hence, the computer implemented method disclosed herein is a cyclic profit process for the subscribers, the network providers, and the companies being advertised by the network providers.

In an embodiment, the advertisement management platform shares the revenue generated from the insertion of the advertisements and/or a sale of one or more products and/or services advertised in the inserted advertisements with one or more of the users based on one or more conditions, for example, duration of the communication sequence, call charges, etc. In an embodiment where revenue is generated from insertion of advertisements and there is no sale of products and/or services, an advertiser can pay a subscriber directly for allowing insertion of the advertisements in the communication sequence. In an embodiment, the advertisement management platform hosted by an advertiser shares revenue with the network provider. The advertiser that provides the advertisements will pay the network provider once and then revenue sharing will be managed by the advertiser and the subscriber.

In an embodiment, the advertisement management platform transfers the communication sequence between the subscriber and the caller or between multiple users to a marketing entity via multiple communication modes for facilitating the purchase of the products and/or services advertised in the inserted advertisements. As used herein, the term “marketing entity” refers to a professional, a team of professionals, or an organization that engages in marketing, publicity, promotion, sale, etc., of a product and/or a service. The marketing entity is, for example, an advertiser, a seller, a customer care representative, a sales representative, etc. The communication modes are, for example, electronic mail (email), a short message service (SMS) message, a multimedia messaging service (MMS) message, etc. In an example, a telecom company automatically transfers a phone call of a subscriber and/or a caller interested in purchasing a product and/or a service advertised in an advertisement tune inserted in the ring back tone, to a sales department of the company of the advertised product and/or service. A sales representative at the sales department who received the transferred phone call provides more information on the advertised product to the subscriber and/or the caller. In an embodiment, if the subscriber intends to purchase an advertised product, the subscriber speaks the product name and/or the product category, and the network provider forwards the communication sequence of the subscriber to a relevant advertising or sales professional of the company selling the advertised product.

In an embodiment, the advertisement management platform provides one or more offers to multiple users comprising, for example, subscribers and callers for enabling the users to perform a bulk purchase of the products and/or the services advertised in the inserted advertisements. For example, at the start or the end of a phone call, a subscriber and/or a caller hears an advertisement or views a video advertisement that provides the subscriber and/or the caller options to subscribe for an offer. At the end of a particular time, for example, one or more days, one or more weeks, one or more months, etc., depending on the offer made to the subscriber and/or the caller in the advertisement, if a predetermined number of users opt for the offer or the sale threshold is reached, then the offer is made available to all the users.

In an embodiment, payment for purchasing the advertised product can be processed by the network provider advertising the product. In an embodiment, the network provider charges a company that sells its products to consumers via a network of the network provider. For example, for every product advertised by a telecom company in an advertisement inserted in a ring back tone, or in an advertisement inserted at the end of a phone call, or in between the phone call, etc., that a subscriber purchases, the telecom company earns a predetermined percentage of profit earned by the company in selling the product via the telecom company. In an embodiment, a company selling a product hires a third party entity to create advertisements for advertising the product via the network provider. In this embodiment, the network provider shares the revenue generated by the advertisement or the sale of the advertised product with the third party entity, or the company directly shares the generated revenue with the third party entity.

In an embodiment, the advertisement management platform executes a sale for one or more slots of the communication sequence from a network provider to another network provider for enabling the other network provider to insert the advertisements in those slots of the communication sequence. The advertisement management platform enables one network provider to sell advertisement slots to another network provider. For example, a telecom company A sells a contract for its 10 subscribers to a telecom company B for insertion of advertisements in the phone calls of the 10 subscribers that use telecom services of the telecom company A. Hence, the telecom company B can insert advertisements for a predetermined time slot, for example, a daily time slot, an hourly time slot, a minutely time slot, a monthly time slot, a yearly time slot, etc., in the phone calls received by the 10 subscribers via a network of the telecom company A. In another example, a product company that sells products shares revenue generated by the insertion of advertisements of its products with the telecom company A and/or the telecom company B. In this example, the telecom company A has a technology or a license to implement the computer implemented method for advertising, while the telecom company B has advertisers to advertise the products of the product company. In an example, the telecom company B pays a certain amount of the revenue generated to the telecom company A for inserting the telecom company B's advertisements associated with the products of the product company in the phone calls of the 10 subscribers of the telecom company A.

In an embodiment, the advertisement management platform manages a gaming activity at configurable time instants of the communication sequence and executes a payment transaction with one or more of the users for participating in the gaming activity. The gaming activity is, for example, a lottery, a jackpot quiz, etc. The configurable time instants of the communication sequence comprise, for example, an initiation, an active state, an engaged state, a termination, a hold state, etc., of the communication sequence. In this embodiment, the option to participate in the gaming activity is provided, for example, at the start, the end, an active period, or a hold period of the communication sequence. Subscribers and/or callers can make payments associated with the gaming activity to the network provider at the configurable time instants of the communication sequence. For example, a subscriber and/or a caller engaged in a phone call, hear an advertisement to participate in a lottery at the start of the phone call. The subscriber and/or the caller are provided with an option to punch in a lottery ticket number at the start or the end of the phone call. In another example, the subscriber and/or the caller may press a button or speak a code and select numbers for the lottery ticket.

In an embodiment, the advertisement management platform analyzes the communication sequence between the users, for example, the subscriber and the caller, and targets and inserts one or more advertisements in the communication sequence based on the analysis of the communication sequence between the subscriber and the caller. In an embodiment, the advertisement management platform acquires permission from the subscriber and the caller to allow the analysis of the communication sequence between the subscriber and the caller. In another embodiment, the advertisement management platform does not request permission from the subscriber and the caller to allow the analysis of the communication sequence between the subscriber and the caller, depending on communication privacy laws of a country to which the subscriber and the caller belong. In this embodiment, receiving permission from the subscriber and/or the caller by the advertisement management platform is not required, but may be retained as an option. Since the analysis of the communication sequence between the subscriber and the caller is performed by the advertisement management platform which is implemented as an electronic system, the communication privacy of the subscriber and the caller is not breached. Hence, depending on the communication privacy laws of a country, the network provider implementing the advertisement management platform may or may not seek permission from the subscriber and/or the caller to analyze the communication sequence between them. The advertisement management platform inserts targeted advertisements in a conversation between a subscriber and a caller by listening to the conversation and presenting the advertisements based on the conversation. For example, if a subscriber, John using a smart phone talks about mobile phones with a caller, Joe, then the advertisement management platform automatically analyzes the key phrase “mobile phones” and places advertisements related to mobile phones, for example, at one or more of an end of the phone call, during the phone call, during the next phone call, etc.

Consider an example where a telecom company joins hands with a product company Z that wishes to advertise its products through the telecom company. The telecom company replaces the ring back tone, which the caller hears, with an advertisement tune with the permission of the subscriber. Consider an example where a subscriber C uses telecom services of a telecom company T. The telecom company T with the permission of the subscriber C sets the ring back tone of the subscriber C to play an advertisement created for a product of a product company Z. In an embodiment, the played advertisement is a short advertisement specifically designed for this medium of advertisement. If another subscriber D calls the subscriber C, the subscriber D hears the advertisement tune until the phone call is received by the subscriber C. Consider another example where a subscriber E is using telecom services of the telecom company T, and the telecom company T sets the ring back tone of the subscriber E to play an advertisement created for a product of a product company W without requesting permission from the subscriber E. When another subscriber F calls the subscriber E, the subscriber F hears the advertisement tune until the phone call is received by the subscriber E.

The telecom company T shares the generated revenue earned from the product company Z with the subscriber C. In an embodiment, the percentage of the generated revenue to be shared with the subscriber C is determined based on the number of incoming phone calls received by the subscriber C. In another embodiment, the percentage of the generated revenue to be shared with the subscriber is either predefined by the product company that provides the advertisement tune for its product to be set as the ring back tone for the subscriber or based on the type of advertisement that is being set as the advertisement tune. For example, the advertisement tune of the product company Z may fetch the subscriber C $X, whereas an advertisement tune of the product company W, can fetch the subscriber C $Y. In an embodiment, the payment from the telecom company T to the subscriber C is, for example, in the form of a check or the amount of payment is remunerated by deducting the payment account from the subscriber C's phone bill.

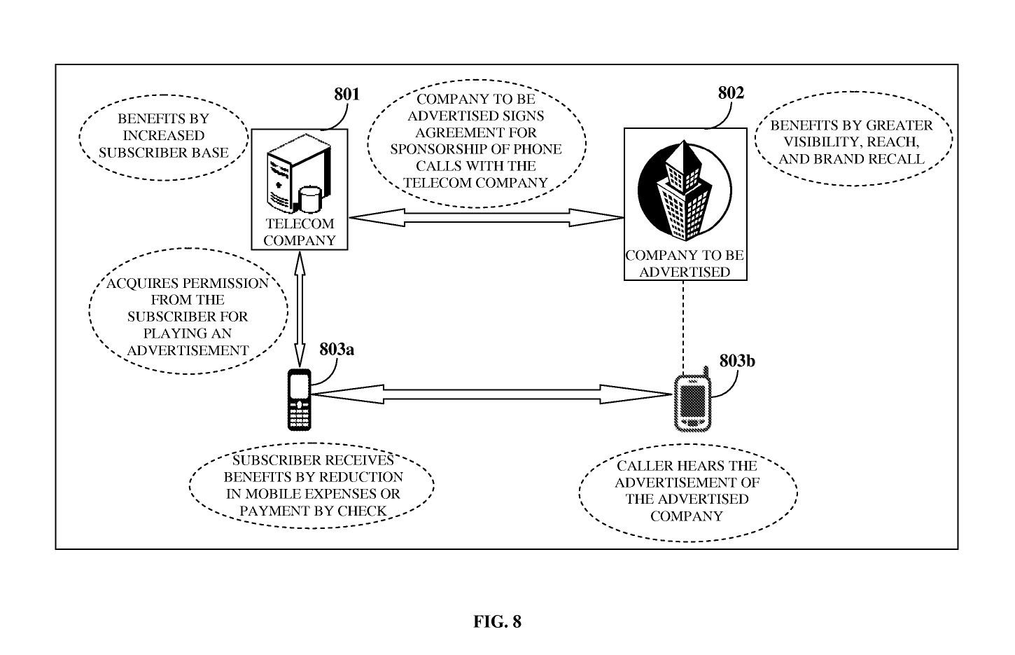

FIG. 8 exemplarily illustrates a flow diagram showing interactions between a telecommunication (telecom) company 801, a company 802 to be advertised, and users according to the computer implemented method disclosed herein. A company 802 wishing to advertise its products signs an agreement for sponsorship of phone calls with the telecom company 801. With the help of the telecom company 801 for marketing the products of the company 802, the company 802 gains benefits of greater visibility, reach, and brand recall. The telecom company 801 agrees to insert advertisement tunes created and provided by the company 802 in the phone calls. In an embodiment, the telecom company 801 acquires permission from a subscriber through a communication device 803a of the subscriber for playing an advertisement tune or an advertisement ring back tone, when a caller using another communication device 803b attempts to call the subscriber. Once the subscriber permits the telecom company 801 to insert the advertisement tune, the caller hears the advertisement tune of the advertised company 802. The telecom company 801 shares a portion of the revenue generated by insertion of the advertisements with the subscriber. The subscriber receives benefits, for example, by obtaining a reduction in mobile expenses or by a payment by check as remuneration from the telecom company 801. In return, the telecom company 801 obtains benefits by increasing its subscriber base.

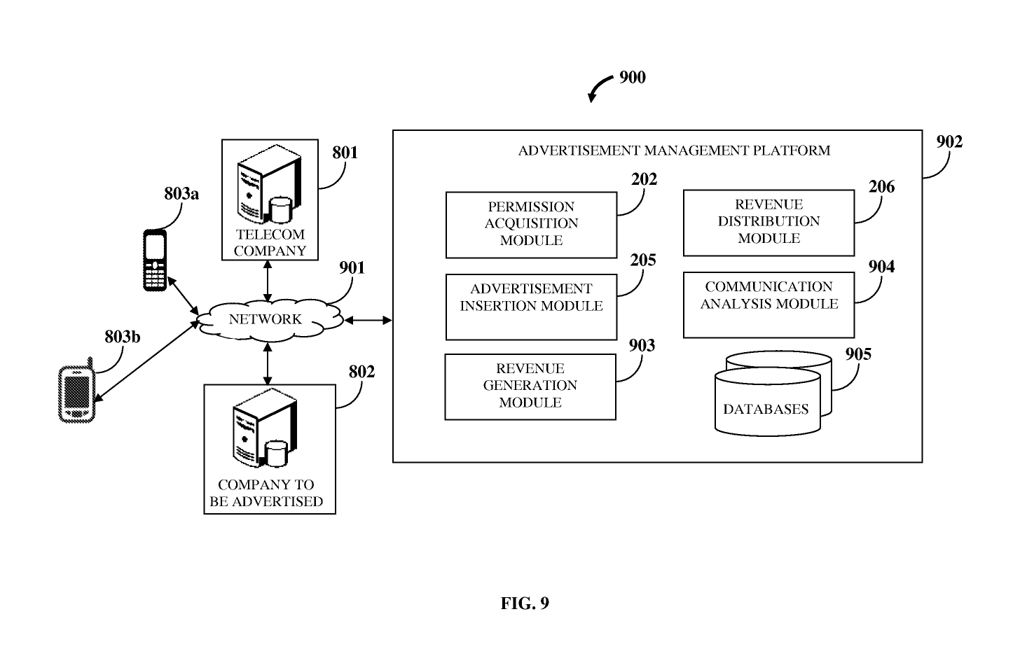

FIG. 9 exemplarily illustrates a computer implemented system 900 for advertising. The computer implemented system 900 disclosed herein comprises the advertisement management platform 902 accessible to a network provider such as a telecom company 801, a company 802 to be advertised, etc., via a network 901, for example, the internet, a mobile telecommunication network, etc. The advertisement management platform 902 comprises a non-transitory computer readable storage medium such as a memory and at least one processor communicatively coupled to the non-transitory computer readable storage medium. As used herein, the term “non-transitory computer readable storage medium” refers to all computer readable media, for example, non-volatile media such as optical discs or magnetic disks, volatile media such as a register memory, a processor cache, etc., and transmission media such as wires that constitute a system bus coupled to the processor, except for a transitory, propagating signal. The non-transitory computer readable storage medium stores modules, for example, 202, 205, 206, 903, 904, etc., of the advertisement management platform 902. The processor executes the modules, for example, 202, 205, 206, 903, 904, etc., of the advertisement management platform 902. In an embodiment, the advertisement management platform 902 is hosted, for example, by one or more of a network provider, a company 802 to be advertised, a third party entity, an advertiser, etc., and any combination thereof, via the network 901. The advertisement management platform 902 is also accessible to one or more communication devices, for example, a mobile phone 803a, a tablet phone 803b, etc., over the network 901. In an embodiment, the advertisement management platform 902 is accessible through multiple browsers, for example, Internet Explorer® (IE) 7, IE 8, and IE 9 of Microsoft Corporation, Mozilla® Firefox® of Mozilla Foundation, Safari® of Apple Inc., Chrome of Google, Inc., etc., and is compatible with technologies, for example, hypertext markup language 5 (HTML5), etc. In another embodiment, the advertisement management platform 902 can be accessed through a software application not available through browsers depending on the technology used to develop the software application.

The advertisement management platform 902 further comprises the modules, for example, 202, 205, 206, 903, 904, etc., executable by the processor for advertising. The advertisement management platform 902 comprises the advertisement insertion module 205, a revenue generation module 903, the revenue distribution module 206, and a communication analysis module 904. The advertisement management platform 902 further comprises databases 905. The databases 905 comprise, for example, the advertisement database 203, the subscriber database 204, etc., as exemplarily illustrated in FIG. 2. The databases 905 comprise, for example, a structured query language (SQL) data store or a not only SQL (NoSQL) data store such as the Microsoft® SQL Server®, the Oracle® servers, the MySQL® database of MySQL AB Company, etc. In an embodiment, each of the databases 905 can also be a location on a file system. The databases 905 may be any storage area or medium that can be used for storing data and files. In another embodiment, the databases 905 can be remotely accessed by the advertisement management platform 902 via the network 901. In another embodiment, the databases 905 is configured as cloud based databases implemented in a cloud computing environment, where computing resources are delivered as a service over the network 901, for example, the internet. In an embodiment, the advertisement management platform 902 further comprises the permission acquisition module 202 for acquiring permission from one or more users for inserting the advertisements. The users comprise, for example, a first user and a second user, or multiple users. As used herein, the terms “first user” and the “second user” refer to entities that communicate with each other through a communication link between their communication devices, for example, 803a, 803b, etc., via the network 901. The first user is, for example, a mobile phone user called by another mobile phone user via a telecommunication or telephone network. The second user is, for example, a mobile phone user calling another mobile phone user via a telecommunication or telephone network. Multiple users refer to a group of entities engaged, for example, in a conference call.

The advertisement insertion module 205 inserts one or more advertisements in a communication sequence between the users. The advertisement insertion module 205 inserts one or more advertisements in the communication sequence between the users, for example, by replacing a ring back tone of the communication sequence with the advertisements or by interrupting the communication sequence and presenting the advertisements. In an embodiment, the advertisement insertion module 205 inserts the advertisements before an initiation of the communication sequence. The advertisement insertion module 205 further presents the advertisements within a media message. In an embodiment, the advertisement insertion module 205 inserts one or more advertisements in the communication sequence between the users without acquiring permission from the users.

The revenue generation module 903 generates revenue by advertising, that is, by insertion of the advertisements in the communication sequence. The revenue generation module 903 generates the revenue, for example, based on one or more of a duration of each of the advertisements, a point of the insertion of each of the advertisements in the communication sequence, and a time of the insertion of each of the advertisements in the communication sequence. In an embodiment, the revenue generation module 903 provides an option to purchase one or more products and/or services advertised in the inserted advertisements in the communication sequence to one or more of the users. In an embodiment, the revenue generation module 903 transfers the communication sequence between the users to a marketing entity via multiple communication modes for facilitating the purchase of the products and/or the services advertised in the inserted advertisements. In an embodiment, the revenue generation module 903 executes a payment transaction with one or more of the users during the purchase of the products and/or the services advertised in the inserted advertisements. In an embodiment, the revenue generation module 903 provides one or more offers to multiple users for enabling the users to perform a bulk purchase of the products and/or the services advertised in the inserted advertisements. In another embodiment, the revenue generation module 903 also executes a sale for one or more slots of the communication sequence from one network provider and another network provider for enabling the other network provider to insert one or more advertisements in those slots of the communication sequence. In another embodiment, the revenue generation module 903 manages a gaming activity at configurable time instants of the communication sequence and executes a payment transaction with one or more of the users for participating in the gaming activity.

The revenue distribution module 206 shares the generated revenue with one or more of the users, the network provider, and a third party entity responsible for the insertion of the advertisements. The revenue distribution module 206 shares the revenue generated by a sale of the products and/or the services advertised in the inserted advertisements by a marketing entity with one or more of a network provider that manages the communication sequence, the first user, the second user, multiple users engaged in a conference call, and/or a third party entity responsible for the insertion of the advertisements. The databases 905 store the advertisements, a profile of each of the users, personal preferences, preferred type of advertisements, point of insertion of the advertisements during the communication sequence, the advertising schemes, etc. The communication analysis module 904 analyzes the communication sequence between the users. The advertisement insertion module 205 targets and inserts one or more advertisements in the communication sequence based on the analysis of the communication sequence between the users. In an embodiment, the permission acquisition module 202 receives permission from the users to allow analysis of the communication sequence between the users. In another embodiment, the advertisement insertion module 205 analyzes the communication sequence between the users without acquiring permission from the users.

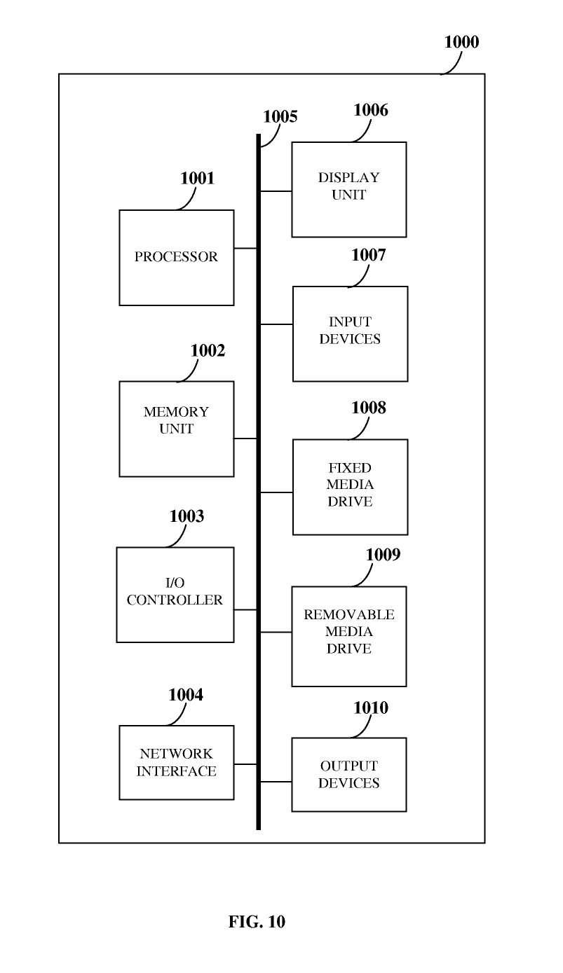

FIG. 10 exemplarily illustrates the architecture of a computer system 1000 employed by the advertisement management platform 902 for advertising. The advertisement management platform 902 of the computer implemented system 900 exemplarily illustrated in FIG. 9 employs the architecture of the computer system 1000 exemplarily illustrated in FIG. 10. The computer system 1000 is programmable using a high level computer programming language. The computer system 1000 may be implemented using programmed and purposeful hardware.

The advertisement management platform 902 communicates with the communication devices, for example, 803a, 803b, etc., of the users, for example, subscribers, callers, etc., registered with the advertisement management platform 902 via a network 901, for example, a short range network or a long range network. The network 901 is, for example, the internet, a mobile communication network, etc. The computer system 1000 comprises, for example, a processor 1001, a non-transitory computer readable storage medium such as a memory unit 1002 for storing programs and data, an input/output (I/O) controller 1003, a network interface 1004, a data bus 1005, a display unit 1006, input devices 1007, a fixed media drive 1008, a removable media drive 1009 for receiving removable media, output devices 1010, etc.

The processor 1001 refers to any one or more microprocessors, central processing unit (CPU) devices, finite state machines, computers, microcontrollers, digital signal processors, logic, a logic device, an electronic circuit, an application specific integrated circuit (ASIC), a field-programmable gate array (FPGA), a chip, etc., or any combination thereof, capable of executing computer programs or a series of commands, instructions, or state transitions. The processor 1001 may also be implemented as a processor set comprising, for example, a general purpose microprocessor and a math or graphics co-processor. The processor 1001 is selected, for example, from the Intel® processors such as the Itanium® microprocessor or the Pentium® processors, Advanced

Micro Devices (AMD®) processors such as the Athlon® processor, UltraSPARC® processors, microSPARC™ processors, hp® processors, International Business Machines (IBM®) processors such as the PowerPC® microprocessor, the MIPS® reduced instruction set computer (RISC) processor of MIPS Technologies, Inc., RISC based computer processors of ARM Holdings, Motorola® processors, Qualcomm® processors, etc. The advertisement management platform 902 disclosed herein is not limited to a computer system 1000 employing a processor 1001. The computer system 1000 may also employ a controller or a microcontroller. The processor 1001 executes the modules, for example, 202, 205, 206, 903, 904, etc., of the advertisement management platform 902.

The memory unit 1002 is used for storing programs, applications, and data. For example, the permission acquisition module 202, the advertisement insertion module 205, the revenue generation module 903, the revenue distribution module 206, the communication analysis module 904, etc., are stored in the memory unit 1002 of the computer system 1000. The memory unit 1002 is, for example, a random access memory (RAM) or another type of dynamic storage device that stores information and instructions for execution by the processor 1001. The memory unit 1002 also stores temporary variables and other intermediate information used during execution of the instructions by the processor 1001. The computer system 1000 further comprises a read only memory (ROM) or another type of static storage device that stores static information and instructions for the processor 1001.

The network interface 1004 enables connection of the computer system 1000 to the network 901. For example, the advertisement management platform 902 connects to the network 901 via the network interface 1004. In an embodiment, the network interface 1004 is provided as an interface card also referred to as a line card. The network interface 1004 comprises, for example, one or more of interfaces based on transmission control protocol (TCP)/internet protocol (IP), interfaces based on wireless communications technology such as satellite technology, radio frequency (RF) technology, near field communication, etc. The I/O controller 1003 controls input actions and output actions performed by the advertisement management platform 902. The data bus 1005 permits communications between the modules, for example, 202, 205, 206, 903, 904, 905, etc., of the advertisement management platform 902.

The display unit 1006 displays information, interfaces, etc., for allowing an administrator of the advertisement management platform 902 to view analysis reports that help in comparing and reviewing the structure and factors impacting advertising schemes, etc. The display unit 1006 comprises, for example, a liquid crystal display, a plasma display, an organic light emitting diode (OLED) based display, etc. The input devices 1007 are used for inputting data into the computer system 1000. The users of the advertisement management platform 902, for example, administrator, etc., use the input devices 1007 to provide inputs to the advertisement management platform 902. For example, an administrator may enter subscriber information, advertisement information, upload analysis reports, and upload customized analysis reports in response to the requests received from a subscriber, etc., using the input devices 1007. The input devices 1007 are, for example, a keyboard such as an alphanumeric keyboard, a microphone, a joystick, a pointing device such as a computer mouse, a touch pad, a light pen, a physical button, a touch sensitive display device, a track ball, a pointing stick, any device capable of sensing a tactile input, etc.

Computer applications and programs are used for operating the computer system 1000. The programs are loaded onto the fixed media drive 1008 and into the memory unit 1002 of the computer system 1000 via the removable media drive 1009. In an embodiment, the computer applications and programs may be loaded directly via the network 901. Computer applications and programs are executed by double clicking a related icon displayed on the display unit 1006 using one of the input devices 1007. The output devices 1010 output the results of operations performed by the advertisement management platform 902.

The processor 1001 executes an operating system, for example, the Linux® operating system, the Unix® operating system, any version of the Microsoft® Windows® operating system, the Mac OS of Apple Inc., the IBM® OS/2, VxWorks® of Wind River Systems, inc., QNX Neutrino® developed by QNX Software Systems Ltd., the Palm OS®, the Solaris operating system developed by Sun Microsystems, Inc., the Android operating system, the Windows Phone® operating system of Microsoft Corporation, the BlackBerry® operating system of Research in Motion Limited, the iOS operating system of Apple Inc., the Symbian® operating system of Symbian Foundation Limited, etc. The computer system 1000 employs the operating system for performing multiple tasks. The operating system is responsible for management and coordination of activities and sharing of resources of the computer system 1000. The operating system further manages security of the computer system 1000, peripheral devices connected to the computer system 1000, and network connections. The operating system employed on the computer system 1000 recognizes, for example, inputs provided by the users using one of the input devices 1007, the output display, files, and directories stored locally on the fixed media drive 1008, for example, a hard drive. The operating system on the computer system 1000 executes different programs using the processor 1001. The processor 1001 and the operating system together define a computer platform for which application programs in high level programming languages are written.

The processor 1001 retrieves instructions for executing the modules, for example, 202, 205, 206, 903, 904, etc., of the advertisement management platform 902 from the memory unit 1002. A program counter determines the location of the instructions in the memory unit 1002. The program counter stores a number that identifies the current position in the program of each of the modules, for example, 202, 205, 206, 903, 904, etc., of the advertisement management platform 902. The instructions fetched by the processor 1001 from the memory unit 1002 after being processed are decoded. The instructions are stored in an instruction register in the processor 1001. After processing and decoding, the processor 1001 executes the instructions. For example, the permission acquisition module 202 defines instructions for acquiring permission from one or more of the users for inserting one or more advertisements in a communication sequence between the users. The advertisement insertion module 205 defines instructions for inserting one or more advertisements in the communication sequence between the users. In an embodiment, the advertisement insertion module 205 defines instructions for replacing a ring back tone of the communication sequence with one or more advertisements. In an embodiment, the advertisement insertion module 205 defines instructions for interrupting the communication sequence and presenting the advertisements. The advertisement insertion module 205 further defines instructions for inserting the advertisements before an initiation of the communication sequence. The advertisement insertion module 205 further defines instructions for presenting one or more advertisements within a media message.

The revenue generation module 903 defines instructions for generating the revenue from insertion of the advertisements. The revenue generation module 903 defines instructions for generating the revenue, for example, based on one or more of a duration of each of the advertisements, a point of insertion of each of the advertisements in the communication sequence, and a time of insertion of each of the advertisements in the communication sequence. Furthermore, the revenue generation module 903 defines instructions for providing an option to purchase one or more products and/or services advertised in the inserted advertisements in the communication sequence to one or more of the users. The revenue generation module 903 also defines instructions for transferring the communication sequence between the users to a marketing entity via multiple communication modes for facilitating purchase of the products and/or the services advertised in the inserted advertisements. Furthermore, the revenue generation module 903 defines instructions for executing a payment transaction with one or more of the users during the purchase of one or more products and/or services advertised in the inserted advertisements.

Furthermore, the revenue generation module 903 also defines instructions for providing one or more offers to multiple users for enabling the users to perform a bulk purchase of the products and/or services advertised in the inserted advertisements. The revenue generation module 903 defines instructions for executing a sale for one or more slots of the communication sequence from one network provider to another network provider for enabling the other network provider to insert one or more advertisements in those slots of the communication sequence. The revenue generation module 903 also defines instructions for managing a gaming activity at configurable time instants of the communication sequence and executing a payment transaction with one or more of the users for participating in the gaming activity.

The revenue distribution module 206 defines instructions for sharing the generated revenue with one or more of the users, the network provider, and a third party entity responsible for the insertion of the advertisements. In an embodiment, the revenue distribution module 206 also defines instructions for sharing revenue generated by a sale of the products and/or the services advertised in the inserted advertisements by a marketing entity with a network provider that manages the communication sequence, one or more users, and a third party entity responsible for the insertion of the advertisements. In an embodiment, the permission acquisition module 202 defines instructions for receiving permission from one or more of the users to allow analysis of the communication sequence between the users. The communication analysis module 904 defines instructions for analyzing the communication sequence between the users. The advertisement insertion module 205 defines instructions for targeting and inserting the advertisements in the communication sequence based on the analysis of the communication sequence between the users.

The processor 1001 of the computer system 1000 employed by the advertisement management platform 902 retrieves the instructions defined by the permission acquisition module 202, the advertisement insertion module 205, the revenue generation module 903, the revenue distribution module 206, the communication analysis module 904, etc., of the advertisement management platform 902, and executes the instructions, thereby performing one or more processes defined by those instructions.

At the time of execution, the instructions stored in the instruction register are examined to determine the operations to be performed. The processor 1001 then performs the specified operations. The operations comprise arithmetic operations and logic operations. The operating system performs multiple routines for performing a number of tasks required to assign the input devices 1007, the output devices 1010, and memory for execution of the modules, for example, 202, 205, 206, 903, 904, etc., of the advertisement management platform 902. The tasks performed by the operating system comprise, for example, assigning memory to the modules, for example, 202, 205, 206, 903, 904, etc., of the advertisement management platform 902, and to data used by the advertisement management platform 902, moving data between the memory unit 1002 and disk units, and handling input/output operations. The operating system performs the tasks on request by the operations and after performing the tasks, the operating system transfers the execution control back to the processor 1001. The processor 1001 continues the execution to obtain one or more outputs. The outputs of the execution of the modules, for example, 202, 205, 206, 903, 904, etc., of the advertisement management platform 902 are displayed to the user on the display unit 1006.

For purposes of illustration, the detailed description refers to the advertisement management platform 902 being run locally on the computer system 1000; however the scope of the computer implemented method and system 900 disclosed herein is not limited to the advertisement management platform 902 being run locally on the computer system 1000 via the operating system and the processor 1001, but may be extended to run remotely over the network 901 by employing a web browser and a remote server, a mobile phone, or other electronic devices. One or more portions of the computer system 1000 may be distributed across one or more computer systems (not shown) coupled to the network 901.

Disclosed herein is also a computer program product comprising a non-transitory computer readable storage medium that stores computer program codes comprising instructions executable by at least one processor 1001 for advertising according to the computer implemented method disclosed herein. The computer program product disclosed herein comprises a first computer program code for inserting one or more advertisements in a communication sequence between the users. The first computer program code comprises a second computer program code for replacing a ring back tone of the communication sequence with the advertisements or a third computer program code for interrupting the communication sequence and presenting the advertisements. The computer program product disclosed herein further comprises a fourth computer program code for analyzing the communication sequence between the users, and a fifth computer program code for targeting and inserting one or more advertisements in the communication sequence based on the analysis of the communication sequence between the users. The computer program product disclosed herein further comprises one or more additional computer program codes for performing additional steps that may be required and contemplated for advertising according to the computer implemented method disclosed herein. In an embodiment, a single piece of computer program code comprising computer executable instructions performs one or more steps of the computer implemented method disclosed herein for advertising.

The computer program codes comprising computer executable instructions are embodied on the non-transitory computer readable storage medium. The processor 1001 of the computer system 1000 retrieves these computer executable instructions and executes them. When the computer executable instructions are executed by the processor 1001, the computer executable instructions cause the processor 1001 to perform the steps of the computer implemented method for advertising.

It will be readily apparent that the various methods, algorithms, and computer programs disclosed herein may be implemented on computer readable media appropriately programmed for computing devices. As used herein, the term “computer readable media” refers to non-transitory computer readable media that participate in providing data, for example, instructions that may be read by a computer, a processor or a similar device. Non-transitory computer readable media comprise all computer readable media, for example, non-volatile media, volatile media, and transmission media, except for a transitory, propagating signal. Non-volatile media comprise, for example, optical discs or magnetic disks and other persistent memory volatile media including a dynamic random access memory (DRAM), which typically constitutes a main memory. Volatile media comprise, for example, a register memory, a processor cache, a random access memory (RAM), etc. Transmission media comprise, for example, coaxial cables, copper wire, fiber optic cables, modems, etc., including wires that constitute a system bus coupled to a processor, etc. Common forms of computer readable media comprise, for example, a floppy disk, a flexible disk, a hard disk, magnetic tape, a laser disc, a Blu-ray Disc®, any magnetic medium, a compact disc-read only memory (CD-ROM), a digital versatile disc (DVD), any optical medium, a flash memory card, punch cards, paper tape, any other physical medium with patterns of holes, a random access memory (RAM), a programmable read only memory (PROM), an erasable programmable read only memory (EPROM), an electrically erasable programmable read only memory (EEPROM), a flash memory, any other memory chip or cartridge, or any other medium from which a computer can read.

The computer programs that implement the methods and algorithms disclosed herein may be stored and transmitted using a variety of media, for example, the computer readable media in a number of manners. In an embodiment, hard-wired circuitry or custom hardware may be used in place of, or in combination with, software instructions for implementation of the processes of various embodiments. Therefore, the embodiments are not limited to any specific combination of hardware and software. In general, the computer program codes comprising computer executable instructions may be implemented in any programming language. Some examples of programming languages that can be used comprise C, C++, C#, Java®, JavaScript®, Fortran, Ruby, Pascal, Perl®, Python®, Visual Basic®, hypertext preprocessor (PHP), Microsoft® .NET, etc. Other object-oriented, functional, scripting, and/or logical programming languages may also be used. The computer program codes or software programs may be stored on or in one or more mediums as object code. Various aspects of the method and system disclosed herein may be implemented as programmed elements, or non-programmed elements, or any suitable combination thereof. The computer program product disclosed herein comprises computer executable instructions embodied in a non-transitory computer readable storage medium, wherein the computer program product comprises one or more computer program codes for implementing the processes of various embodiments.

Where databases are described such as the databases 905 exemplarily illustrated in FIG. 9, comprising the advertisement database 203, the subscriber database 204, etc., exemplarily illustrated in FIG. 2, it will be understood by one of ordinary skill in the art that (i) alternative database structures to those described may be readily employed, and (ii) other memory structures besides databases may be readily employed. Any illustrations or descriptions of any sample databases disclosed herein are illustrative arrangements for stored representations of information. Any number of other arrangements may be employed besides those suggested by tables illustrated in the drawings or elsewhere. Similarly, any illustrated entries of the databases represent exemplary information only; one of ordinary skill in the art will understand that the number and content of the entries can be different from those disclosed herein. Further, despite any depiction of the databases as tables, other formats including relational databases, object-based models, and/or distributed databases may be used to store and manipulate the data types disclosed herein. Likewise, object methods or behaviors of a database can be used to implement various processes such as those disclosed herein. In addition, the databases may, in a known manner, be stored locally or remotely from a device that accesses data in such a database. In embodiments where there are multiple databases in the system, the databases may be integrated to communicate with each other for enabling simultaneous updates of data linked across the databases, when there are any updates to the data in one of the databases.

The present invention can be configured to work in a network environment comprising one or more computers that are in communication with one or more devices via a network. The computers may communicate with the devices directly or indirectly, via a wired medium or a wireless medium such as the Internet, a local area network (LAN), a wide area network (WAN) or the Ethernet, a token ring, or via any appropriate communications mediums or combination of communications mediums. Each of the devices comprises processors, some examples of which are disclosed above, that are adapted to communicate with the computers. In an embodiment, each of the computers is equipped with a network communication device, for example, a network interface card, a modem, or other network connection device suitable for connecting to a network. Each of the computers and the devices executes an operating system, some examples of which are disclosed above. While the operating system may differ depending on the type of computer, the operating system will continue to provide the appropriate communications protocols to establish communication links with the network. Any number and type of machines may be in communication with the computers.

The present invention is not limited to a particular computer system platform, processor, operating system, or network. One or more aspects of the present invention may be distributed among one or more computer systems, for example, servers configured to provide one or more services to one or more client computers, or to perform a complete task in a distributed system. For example, one or more aspects of the present invention may be performed on a client-server system that comprises components distributed among one or more server systems that perform multiple functions according to various embodiments. These components comprise, for example, executable, intermediate, or interpreted code, which communicate over a network using a communication protocol. The present invention is not limited to be executable on any particular system or group of systems, and is not limited to any particular distributed architecture, network, or communication protocol.

The foregoing examples have been provided merely for the purpose of explanation and are in no way to be construed as limiting of the present invention disclosed herein. While the invention has been described with reference to various embodiments, it is understood that the words, which have been used herein, are words of description and illustration, rather than words of limitation. Further, although the invention has been described herein with reference to particular means, materials, and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention in its aspects.

I claim:

1. A computer implemented method for advertising, comprising:
providing an advertisement management platform comprising at least one processor configured to generate revenue by said advertising; and
inserting one or more advertisements in a communication sequence between users by said advertisement management platform, comprising one of:
replacing a ring back tone of said communication sequence with said one or more advertisements; and
interrupting said communication sequence and presenting said one or more advertisements.

2. The computer implemented method of claim 1, further comprising generating said revenue from said insertion of said one or more advertisements by said advertisement management platform and sharing said generated revenue with one or more of said users, a network provider, and a third party entity responsible for said insertion of said one or more advertisements.

3. The computer implemented method of claim 1, further comprising generating said revenue by said advertisement management platform based on one or more of a duration of each of said one or more advertisements, a point of said insertion of each of said one or more advertisements in said communication sequence, and a time of said insertion of each of said one or more advertisements in said communication sequence.

4. The computer implemented method of claim 1, further comprising acquiring permission from one or more of said users by said advertisement management platform for said insertion of said one or more advertisements.

5. The computer implemented method of claim 1, wherein said one or more advertisements are inserted by said advertisement management platform before an initiation of said communication sequence.

6. The computer implemented method of claim 1, further comprising presenting said one or more advertisements within a media message by said advertisement management platform, wherein said media message is one of a text short message service message, a voice short message service message, a multimedia messaging service message, an enhanced messaging service message, and an extended messaging service message of a subscribing user.

7. The computer implemented method of claim 1, further comprising providing an option to purchase one or more of products and services advertised in said inserted one or more advertisements in said communication sequence to one or more of said users by said advertisement management platform.

8. The computer implemented method of claim 7, further comprising transferring said communication sequence between said users to a marketing entity via a plurality of communication modes by said advertisement management platform for facilitating said purchase of said one or more of said products and said services advertised in said inserted one or more advertisements.

9. The computer implemented method of claim 7, further comprising sharing revenue generated by a sale of said one or more of said products and said services advertised in said inserted one or more advertisements by a marketing entity with one or more of a network provider that manages said communication sequence, one or more of said users, and a third party entity responsible for said insertion of said one or more advertisements, via said advertisement management platform.

10. The computer implemented method of claim 7, further comprising executing a payment transaction with one or more of said users by said advertisement management platform during said purchase of said one or more of said products and said services advertised in said inserted one or more advertisements.

11. The computer implemented method of claim 1, further comprising sharing said revenue generated from one or more of said insertion of said one or more advertisements and a sale of one or more of products and services advertised in said inserted one or more advertisements with one or more of said users by said advertisement management platform based on one or more conditions.

12. The computer implemented method of claim 1, further comprising providing one or more offers to a plurality of said users by said advertisement management platform for enabling said users to perform a bulk purchase of one or more of products and services advertised in said inserted one or more advertisements.

13. The computer implemented method of claim 1, further comprising executing a sale for one or more slots of said communication sequence from a first network provider to a second network provider by said advertisement management platform for enabling said second network provider to insert said one or more advertisements in said one or more slots of said communication sequence.

14. The computer implemented method of claim 1, further comprising analyzing said communication sequence between said users by said advertisement management platform, and targeting and inserting said one or more advertisements in said communication sequence by said advertisement management platform based on said analysis of said communication sequence between said users.

15. The computer implemented method of claim 14, further comprising acquiring permission from one or more of said users by said advertisement management platform to allow said analysis of said communication sequence between said users.

16. The computer implemented method of claim 1, further comprising managing a gaming activity at configurable time instants of said communication sequence and executing a payment transaction with one or more of said users for participating in said gaming activity by said advertisement management platform.

17. A computer implemented system for advertising, comprising:
an advertisement management platform comprising:
a non-transitory computer readable storage medium configured to store modules of said advertisement management platform;
at least one processor communicatively coupled to said non-transitory computer readable storage medium, said at least one processor configured to execute said modules of said advertisement management platform; and
said modules of said advertisement management platform comprising:
an advertisement insertion module configured to insert one or more advertisements in a communication sequence between users by performing one of:
replacing a ring back tone of said communication sequence with said one or more advertisements; and
interrupting said communication sequence and presenting said one or more advertisements; and
a revenue generation module configured to generate revenue from said insertion of said one or more advertisements.

18. The computer implemented system of claim 17, wherein said modules of said advertisement management platform further comprise a revenue distribution module configured to share said generated revenue with one or more of said users, a network provider, and a third party entity responsible for said insertion of said one or more advertisements.

19. The computer implemented system of claim 17, wherein said revenue generation module is further configured to generate said revenue based on one or more of a duration of each of said one or more advertisements, a point of said insertion of each of said one or more advertisements in said communication sequence, and a time of said insertion of each of said one or more advertisements in said communication sequence.

20. The computer implemented system of claim 17, wherein said modules of said advertisement management platform further comprise a permission acquisition module configured to acquire permission from one or more of said users for said insertion of said one or more advertisements.

21. The computer implemented system of claim 17, wherein said advertisement insertion module is further configured to present said one or more advertisements within a media message, wherein said media message is one of a text short message service message, a voice short message service message, a multimedia messaging service message, an enhanced messaging service message, and an extended messaging service message of a subscribing user.

22. The computer implemented system of claim 17, wherein said revenue generation module is further configured to provide an option to purchase one or more of products and services advertised in said inserted one or more advertisements in said communication sequence to one or more of said users.

23. The computer implemented system of claim 22, wherein said revenue generation module is further configured to transfer said communication sequence between said users to a marketing entity via a plurality of communication modes for facilitating said purchase of said one or more of said products and said services advertised in said inserted one or more advertisements.

24. The computer implemented system of claim 22, wherein said revenue generation module is further configured to execute a payment transaction with one or more of said users during said purchase of said one or more of said products and said services advertised in said inserted one or more advertisements.

25. The computer implemented system of claim 17, wherein said modules of said advertisement management platform further comprise a revenue distribution module configured to share revenue generated by a sale of one or more of products and services advertised in said inserted one or more advertisements by a marketing entity with one or more of a network provider that manages said communication sequence, one or more of said users, and a third party entity responsible for said insertion of said one or more advertisements.

26. The computer implemented system of claim 17, wherein said revenue generation module is further configured to provide one or more offers to a plurality of users for enabling said users to perform a bulk purchase of one or more of products and services advertised in said inserted one or more advertisements.

27. The computer implemented system of claim 17, wherein said revenue generation module is further configured to execute a sale for one or more slots of said communication sequence from a first network provider to a second network provider for enabling said second network provider to insert said one or more advertisements in said one or more slots of said communication sequence.

28. The computer implemented system of claim 17, wherein said modules of said advertisement management platform further comprise a communication analysis module configured to analyze said communication sequence between said users, and wherein said advertisement insertion module is further configured to target and insert said one or more advertisements in said communication sequence based on said analysis of said communication sequence between said users.

29. The computer implemented system of claim 17, wherein said revenue generation module is further configured to manage a gaming activity at configurable time instants of said communication sequence and executing a payment transaction with one or more of said users for participating in said gaming activity.

30. The computer implemented system of claim 17, further comprising one or more databases configured to store said one or more advertisements, a profile of each of said users, personal preferences, preferred type of advertisements, point of said insertion of said one or more advertisements during said communication sequence, and one or more advertising schemes.

31. A computer program product comprising a non-transitory computer readable storage medium, said non-transitory computer readable storage medium storing computer program codes that comprise instructions executable by at least one processor, said computer program codes comprising:
a first computer program code for inserting one or more advertisements in a communication sequence between users, said first computer program code comprising one of:
a second computer program code for replacing a ring back tone of said communication sequence with said one or more advertisements; and
a third computer program code for interrupting said communication sequence and presenting said one or more advertisements.

32. The computer program product of claim 31, further comprising:
a fourth computer program code for analyzing said communication sequence between said users; and
a fifth computer program code for targeting and inserting said one or more advertisements in said communication sequence based on said analysis of said communication sequence between said users.
